(19) United States
(12) Patent Application Publication
(10) Pub. No.: US 2013/0277200 A1
(43) Pub. Date: Oct. 24, 2013

(54) SPRING LOADED PRESSURE RELIEF DEVICE

(71) Applicants: Farzad G. Tahmassi, Carrollton, TX (US); Larry W. Burton, Waxahachie, TX (US); Pai-Yu Polly Chiang, Dallas, TX (US)

(72) Inventors: Farzad G. Tahmassi, Carrollton, TX (US); Larry W. Burton, Waxahachie, TX (US); Pai-Yu Polly Chiang, Dallas, TX (US)

(21) Appl. No.: 13/261,629

(22) PCT Filed: Oct. 18, 2011
(86) PCT No.: PCT/US2011/001771

§ 371 Date: Jul. 3, 2013

Related U.S. Application Data
(60) Provisional application No. 61/344,845, filed on Oct. 22, 2010.

(51) Int. Cl. B01D 3/42

(52) U.S. Cl. CPC B01D 3/42
USPC 202/258

(57) ABSTRACT

A pressure relief device for preventing damage to a tray in a distillation column arising from sudden pressure surges includes a plate normally closing an opening in the tray, a frame above which the tray can move vertically, and at least one spring assembly connecting the plate to the frame. When there is a pressure surge, the plate moves vertically to open the pressure relief device. When the pressure differential between zones above and below the plate has been relieved, the spring assembly returns the pressure relief device to the closed position in which the plate is coplanar with the fixed tray.

### BACKGROUND OF THE INVENTION

1. Field of the Invention

The present invention relates to a presssure relief device for use with distillation trays in chemical process columns.

Several tray designs are known for use in distillation columns (also called towers). In each design, trays are situated within the columns for contact of vapor and liquid between the components of mixtures. Detailed tray designs are described by, for example, Philip C. Wankat in “Equilibrium Staged Separations” published by Elsevier (1988), C. Judson King in “Separation Processes” published by McGraw-Hill Book Company (2^{nd} edition, 1980), Henry Z. Kister in “Distillation Design” published by McGraw-Hill, Inc. (1992), and Johann G. Stichlmair and James R. Fair in “Distillation: Principles and Practice” published by Wiley-VCH (1998).

Distillation columns are designed for the performance of a variety of separation processes, as illustrated in commercial literature available from column manufacturers such as “Trays for Distillation, Absorption, Stripping and Extraction” published by UOP Process Equipment, Tonawanda, N.Y., USA. It will be appreciated that the benefits of the present invention may accrue when the invention is used in designs of trays for different types of column.

Typically, a tray deck is perforated to allow vapor to rise through perforations and bubble through liquid flowing across the tray deck (called a cross-flow tray), thereby effecting contact between the liquid and the vapor. An outlet weir is situated toward the edge of the tray deck adjacent an outlet downcomer, so as to maintain a depth of liquid and froth across the tray deck. The perforations in the deck may include valves, bubble caps, and other devices designed to improve vapor-liquid contact and to control the flow of vapor rising through the perforations.

The safe and efficient operation of a column requires that at all stages within the column there is steady state mass transfer between liquid and vapor phases. To achieve these results, it is necessary to design the tray to handle the desirable vapor and liquid throughputs below tray capacity. However, at different times during operation of a column, and in particular during start up, the potential exists for an excess of one or the other of vapor or liquid to be present at one or more trays within the column. When this non-equilibrium condition occurs, an excessive pressure difference can be created between the zone above and the zone below a tray. Similar phenomena during operation may also occur if the liquid level at the bottom of the column is above the reboiler vapor return inlet. Typically, trays are designed to withstand a limited amount of pressure difference. When that pressure difference is exceeded, damage may occur to the tray and other column internal structure, necessitating considerable down time and expensive repairs. In particular, it is important to be able to relieve sudden pressure surges, and especially when they take place below a tray, because surges can damage the tray. One example of such a pressure surge is when an amount of water is vaporized rapidly to steam at a location within a column. For example, in a typical atmospheric pressure column for distillation of crude oil, flashing of as little as one-third of a cubic foot of water in one second will cause a pressure differential of 1.5 to 2.5 pounds per square inch across one or more stacked distillation trays in the column. Such a pressure differential may cause damage to or displacement of the trays, thereby affecting operation of the column. It is thus desirable that steps are taken to relieve such pressure differentials should they occur.

Chatfield in U.S. Pat. No. 2,045,518 (Jun. 23, 1936) discloses a pressure relief system applicable only to bubble cap trays, but this system reduces distillation capability of the column. Also, the system does not allow relief in the event of rapid development of a pressure differential.

Parsons in U.S. Pat. No. 2,105,501 (Jan. 19, 1938) discloses a circular pressure relief disc that occupies a large proportion of the tray area, and therefore reduces tray capacity.

Constantikes in U.S. Pat. No. 2,809,821 (Oct. 15, 1957) describes a pressure balancing system that does not allow relief of sudden pressure surges.

Gilmore in U.S. Pat. No. 2,846,204 (Aug. 5, 1958) describes plate valves for providing vapor-liquid contact, and these also have some capability of relieving some level of pressure surge. However, the system is expensive, does not have general applicability, and is described by DiNicolantonio in U.S. Pat. No. 4,133,852 (Jan. 9, 1979) as being prone to sticking and jamming.

Doering in U.S. Pat. No. (Oct. 1, 1963) discloses variable opening jet tabs for relief of small pressure surges, and these are limited in utility. Additional apparatus capable of withstanding or relieving small pressure differentials at a tray are described bu Uitti in U.S. Pat. No. 3,632,315 (Jan. 4, 1972), Boon in U.S. Pat. No. 3,649,466 (Mar. 14, 1972), Hirao in U.S. Pat. No. 3,807,711 (Apr. 30, 1974), and Tjutjunnikov in U.S. Pat. No. 3,817,501 (Jun. 18, 1974).

DiNicolantonio et al. in the above-referenced U.S. Pat. No. 4,133,852, disclose a hinged tray design for use preferably in distillation columns, capable of relieving small but sudden pressure surges caused by the flashing of relatively small amounts of water in a column feed or in the stripping steam, described as having superior performance and better capability to relieve sudden pressure surges than the appartuses described in the above patents. However, when the hinged portion of the tray rises at an angle to relieve the pressure differential, the vapor at excess pressure is vented in a directed manner that is determined by the position of the hinge and consequent angle of the hinged portion of the tray, so that the vented material is not uniformly distributed, and consequently could do secondary damage in the area to which it is vented, such as the tray immediately above the tray being vented.

What is needed is an alternative apparatus for relieving a sudden surge below or above a tray in a column by venting material through the tray that more uniformly distributes vapor released to the tray above that being vented.

2. General Description of the Invention

The present invention relates to an improved design for relieving a sudden pressure surge below a tray within a distillation column. A plurality of spring loaded pressure relief devices is incorporated into the deck of the tray. Each device has perforations through which vapor normally rises to mix with liquid flowing across the deck. Each device has a plurality of springs that enable the device to rise above or fall below the level of the remainder of the deck when subject to a pressure surge, and to return the device to deck level when the pressure surge has been relieved, thereby relieving the effects of the pressure surge without interrupting operation of the column and preventing damage to the internals of the column.

The improved design can deliver predictable and evenly distributed pressure relieve during abnormal operation. It can also be incorporated into trays used for vapor-liquid absorption and liquid-liquid extraction columns.

### BRIEF DESCRIPTION OF THE DRAWINGS

For a more complete understanding of the present invention and for further objects and advantages thereof, reference is made to the following description taken in conjunction with the accompanying drawings, wherein:

FIGS. 1 and 2 are isometric views of a portion of a tray in a distillation column having a plurality of spring loaded pressure relief devices in the closed and open positions, respectively;

FIG. 3 is an isometric view of a tray having a plurality of pressure relief devices in the open position;

FIGS. 4 and 5 are isometric views of a portion of a tray and pressure relief device in the closed position;

FIG. 6A is a side view of a pressure relief device in the closed position;

FIG. 6B is a side view of internal components of the pressure relief device of FIG. 6A;

FIG. 7A is a side view of the pressure relief device in the open position; and

FIG. 7B is a side view of internal components of the pressure relief device of FIG. 7A in the open position.

### DESCRIPTION OF THE PREFERRED EMBODIMENT

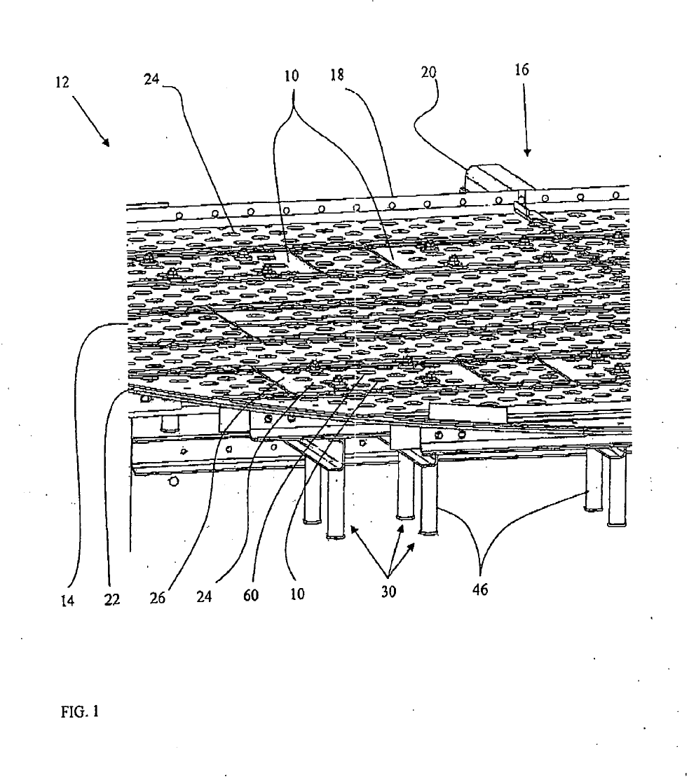

Referring to FIGS. 1 to 3, a tray assembly 12 for vapor/liquid contact is mounted in a distillation column having a side wall (not shown). The outer edge of the tray assembly 12 is connected to the side wall. The tray 12 has a deck 14, which may include one or more sections, and at least one downcomer 16. The deck 14 has perforations 24 through which vapor can rise. It will be appreciated by those skilled in the art that the perforations 24 may be simple holes or include valves, bubble caps or other devices to control and distribute vapor rising through the perforations 24. Typically, the tray 12 has an outlet weir 18 to maintain a depth of a liquid and froth above the deck 14. Additional structural members may be included to maintain the integrity and position of the tray 12 within the column, e.g., the structural member 20 (FIGS. 1 to 3) extending across the downcomer 16 from the tray 12 above the downcomer wall 28 to the inner surface of the column walls.

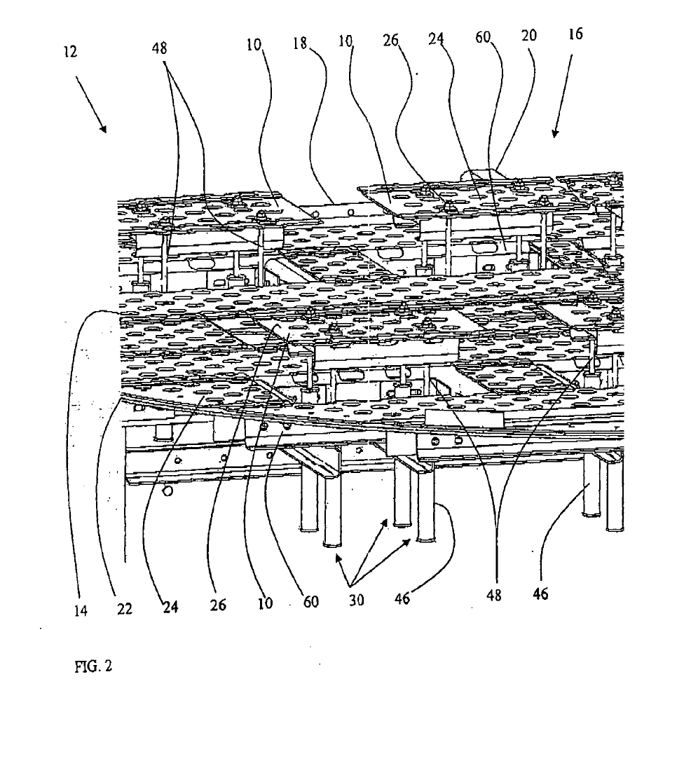

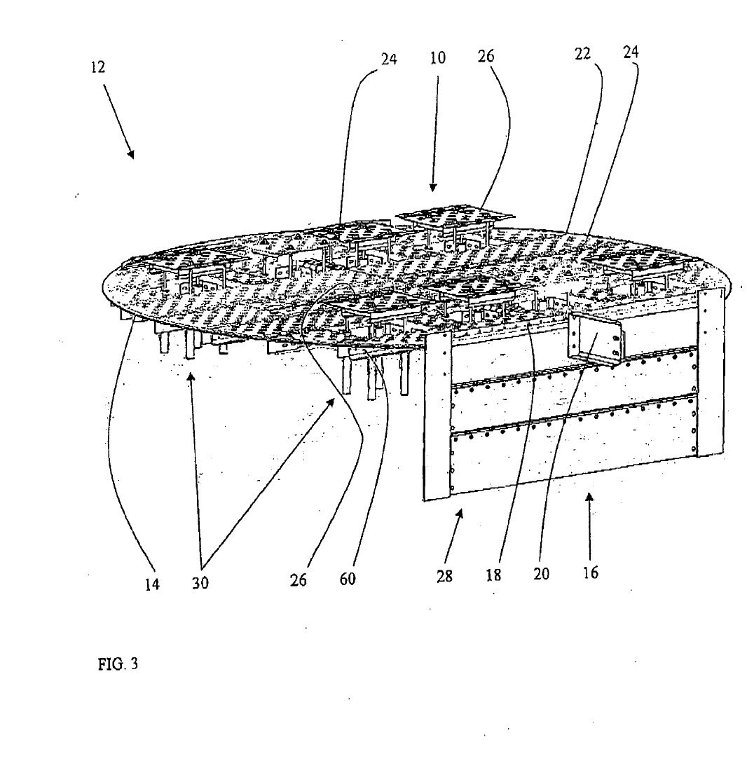

The tray 12 includes a plurality of spring loaded pressure relief devices 10 located across the extent of deck 14. The pressure relief devices 10 are vertically movable relative to a fixed section 62 (FIGS. 4 and 5) of deck 14. FIG. 1 shows the pressure relief devices 10 in the closed position and FIGS. 2 and 3 show the pressure relief devices 10 in the open position. FIGS. 4 and 5 show a single pressure relief device 10 in the closed position. The pressure relief device 10 includes a plate 26 which normally closes an opening in the deck 14, a plurality of spring assemblies 30 and a frame 64. The frame 64 is rigidly connected to the support members 60 of the deck 14. When the pressure relief device 10 is in the closed position, the plate 26 is level (coplanar) with the remaining section 62 of the deck 14. While

FIGS. 4 through 7B show a pressure relief device 10 having eight spring assemblies 30, a number found in practice to provide stable and reproducible operation of the pressure relief device 10, it will be appreciated that any number (even one) spring assemblies 30 can be used. The plate 26 has a plurality of perforations 24 so that when in the closed position the plate 26 serves as a section of deck 14.

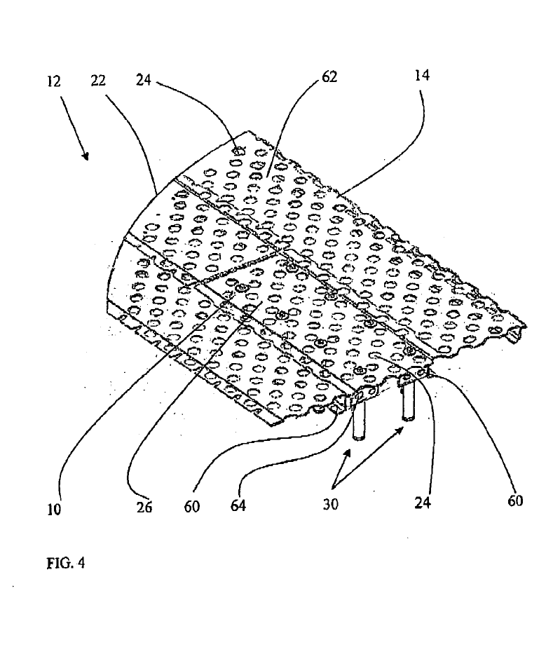

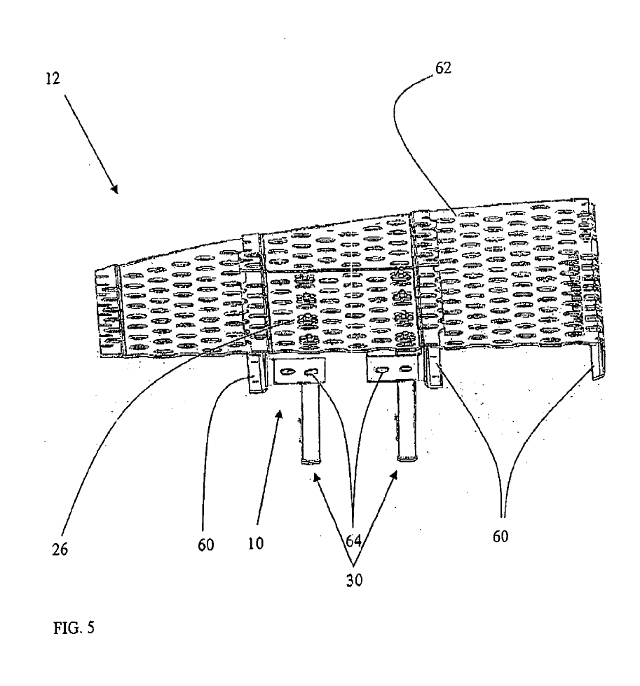

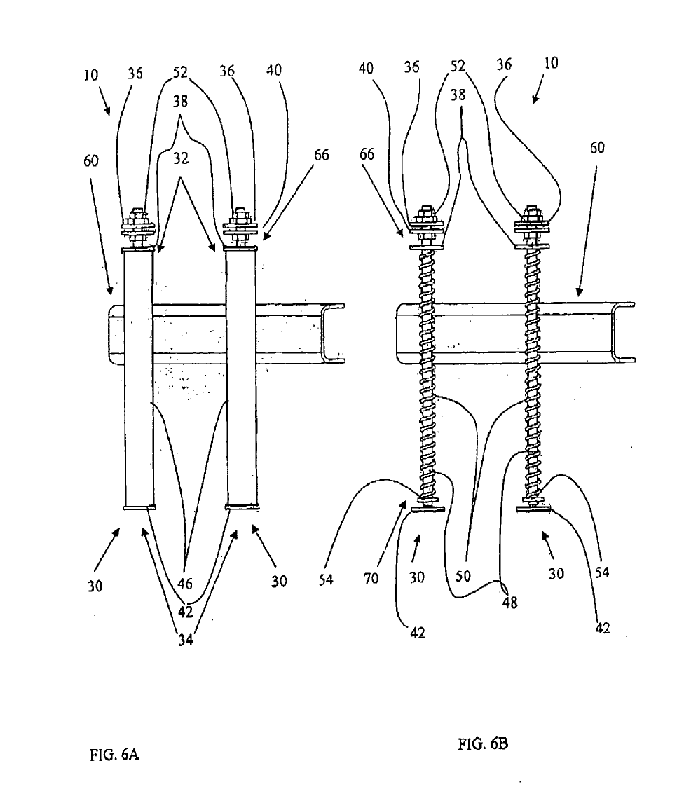

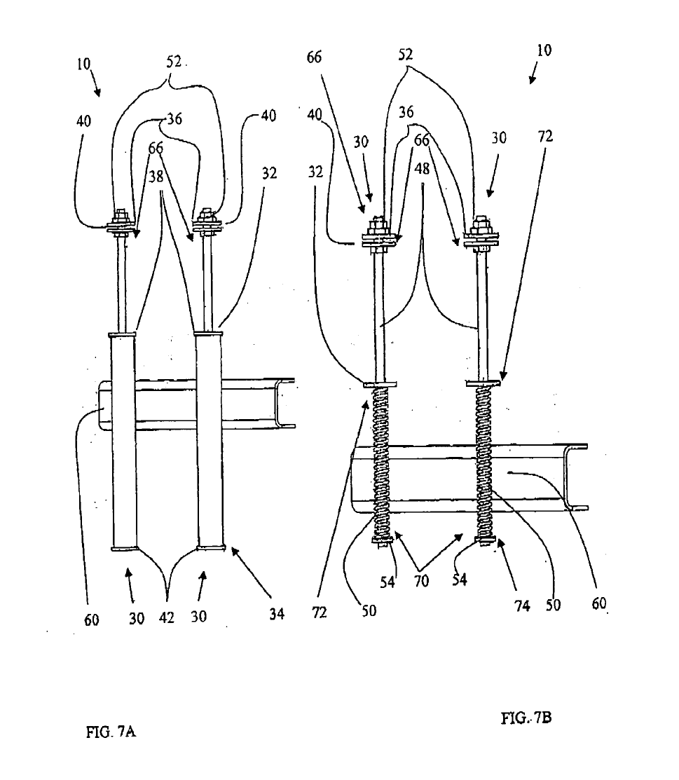

FIGS. 6A and 6B show the spring assemblies 30 when the pressure relief device 10 is in the closed position. Each spring assembly 30 includes a spring 50, a piston 48 and a cylindrical housing 46 defined by a tubular body. The housing 46 has a head 38 at an upper end 32 and a base 42 secured at a lower end 34. The piston 48 has an upper end 66 and a bottom end 70. The spring 50 has a top end 72 and a bottom end 74. As shown in FIGS. 6A to 7B, the housing 46 is secured to the support member 60.

FIGS. 1 to 7B illustrate an embodiment of the invention in which each pressure relief device 10 is vertically movable from a rest or closed position coplanar with the fixed remaining section 62 of the deck 14. It will be appreciated that pressure relief devices 10 can also be installed in an inverted manner relative to deck 14, so that in the open position, the plate 26 moves below the remaining section 62 of the deck 14. It also will be appreciated that several pressure relief devices 10 can be installed with some movable to open positions above the plane of the deck 14 and the remainder movable to open positions below the plane of the deck 14. Thus the invention may be used to relieve sudden pressure surges that occur either above or below the deck 14.

The head 38 of the housing 46 has a hole through which the upper end 66 of the piston 48 extends. When the pressure relief device 10 is in the closed position, the bottom 70 of the piston 48 is adjacent to the base 42 of the housing 46, as shown in FIG. 6B. The upper end 66 of the piston 48 extends above the head 38 of the housing 46. The plate 26 of the pressure relief device 10 is secured at the upper end 66 of the piston 48. The embodiments illustrated in FIGS. 1 through 7B show the plate 26 secured using an upper washer 36 and a lower washer 38 on each side of a space 40 into which the plate 26 is secured, the combination being held in place by a nut 52 on a threaded portion of the piston 48. It will be appreciated that this means of securing the plate 26 to the piston 48 is exemplary and that other means of attachment may be used.

Referring to FIGS. 6A through 7B, the spring 50 is constrained within the housing 46 by the head 38 of the housing 46 and a flange 54 affixed to the bottom 70 of the piston 48. Referring to FIGS. 6A and 6B, when the pressure relief device 10 is in the closed position the spring 50 is extended within the housing 46. Referring to FIGS. 7A and 7B, when there is a sudden pressure surge below deck 14, the pressure relief device 10 opens to relieve the pressure surge, and thus the plate 26 is positioned above the remainder of the deck 14, the piston 48 rises through the head 38 of the housing 46, and the spring 50 is compressed between the head 38 and the flange 54 within the housing 46. When the pressure differential between the zones above and below the deck 14 has been relieved, the compressed spring 50 extends again to return the pressure relief device 10 to the closed position. This sequence of actions is reversible and repeatable.

A sleeve (not illustrated) may be used to guide and protect the piston 48 from abbrasion through contact with the head 38 of the housing 46. Moreover, when the atmosphere about the spring assembly 30 is potentially harmful, such as corrosive vapors, it is beneficial to employ a protective sleeve (not shown) around the piston 48 as it extends through the head 38. The sleeve extends through the head 38 and the piston 48 can slide therein. The protective sleeve isolates the spring 50 from a harmful atmosphere.

1. A pressure relief apparatus for use with a tray having a fixed deck in a distillation column containing a tray with a fixed, perforated deck comprising a plurality of pressure relief devices mounted in and vertically movable relative to the fixed deck, each pressure relief device including:
a perforated plate normally closing an opening in said deck;
a frame secured to the deck;
a spring assembly having a first end connected to said frame and a second end connected to said plate for biasing said plate to a closed position in which the plate covers the opening in the deck;
whereby when there is a pressure surge on the side of the deck opposite said second end of the spring assembly, the plate moves away from the fixed deck to relieve a pressure differential above and below the deck and when the pressure differential above and below the deck has been relieved, the spring assembly returns the plate to the closed position.

2. The pressure relief apparatus of claim 1, wherein said spring assembly includes:
a housing secured to the frame;
a piston slidable in and extending out of one end of said housing, the piston having an outer end connected to said plate; and
a spring in said housing for biasing said piston and consequently said plate to the closed position in which the plate closes the opening in the deck;
whereby when there is a pressure surge on the side of the deck opposite said second end of the spring assembly, the plate moves away from the fixed deck to relieve a pressure differential above and below the deck and when the pressure differential above and below the deck has been relieved, the spring assembly returns the plate to the closed position.

3. The pressure relief apparatus of claim 2, wherein the frame is located beneath the tray deck, and said housing includes a tubular body having a base on the lower end of the body connected to the frame, a head on an upper end of the tubular body, and an opening in said head permitting sliding of the piston vertically out of an into said head.

4. The pressure relief apparatus of claim 3, wherein said spring is a helical spring on said piston, said spring extending between the base of the tubular body and the plate.

5. The pressure relief apparatus of claim 4 including a sleeve in said housing extending from the base through the head of said housing and surrounding said helical spring and piston for protecting the spring and piston.

6. The pressure relief apparatus of claim 1, including a plurality of spring assemblies, each having a first end connected to said frame and a second end connected to said plate.
